(19) United States
(12) Patent Application Publication
(10) Pub. No.: US 2018/0149588 A1
(43) Pub. Date: May 31, 2018

(54) In-Situ Non-Invasive Device for Early Detection of Fouling in Aquatic Systems

(71) Applicant: King Abdullah University of Science and Technology, Thuwal (SA)

(72) Inventors: Luca Fortunato, Thuwal (SA); TorOve Leiknes, Thuwal (SA)

(73) Assignee: King Abdullah University of Science and Technology, Thuwal (SA)

(21) Appl. No.: 15/579,492

(22) PCT Filed: Jun. 30, 2016
(86) PCT No.: PCT/IB2016/053953

§ 371 Date: Dec. 4, 2017

Related U.S. Application Data
(60) Provisional application No. 62/344,665, filed on Jun. 2, 2016.
(60) Provisional application No. 62/187,338, filed on Jul. 1, 2015.

(51) Int. Cl. G01N 21/45; G01N 21/47; G01D 5/26; G01D 5/353; G01N 17/00

(52) U.S. Cl. CPC G01N 21/45; G01N 21/4795; G01D 5/268; G01N 2021/9546; G01N 17/008; G01N 2021/458; G01D 5/35303

(57) ABSTRACT

An in-situ, non-destructive sensor device, system and method are provided to detect or assess fouling at a very early stage of development. They can be used to detect or assess fouling on a surface of an aquatic system. They can be used to obtain a depth profile of the fouling. Data concerning the depth profile can be extracted and used to assess the fouling on the surface, in one or more aspects, the method can include providing an optical tomography spectrometer; optically positioning the optical tomography spectrometer in association with a surface of an area to be assessed for fouling in an aqueous system; irradiating the surface; acquiring, from irradiating the surface, a plurality of signals as a function of a distance from the surface at different times; extracting data from the signals as a function of the distance to obtain a depth profile of the surface at the different times; and determining a change in the depth profile between the different times to assess fouling on the surface.

### CROSS-REFERENCE TO RELATED APPLICATIONS

This application claims the benefit of and priority to U.S. Provisional Application Ser. No. 62/187,338, having the title “IN-SITU NON-INVASIVE DEVICE FOR EARLY DETECTION OF FOULING IN AQUATIC SYSTEMS,” filed on Jul. 1, 2015 and U.S. Provisional Application Ser. No. 62/344,665, having the title “IN-SITU NON-INVASIVE DEVICE FOR EARLY DETECTION OF FOULING IN AQUATIC SYSTEMS,” filed on Jun. 2, 2016, the contents of which are incorporated by reference in their entirety.

### TECHNICAL FIELD

The present disclosure generally relates to detection of fouling in aquatic systems, in particular fouling due to biofouling, organic fouling and/or scaling.

### BACKGROUND

Fouling in an aquatic system is defined as the unwanted deposition and growth of a film or a scale on a surface within the system. It is recognized to be a major issue in different fields that involve the presence of water (e.g. aquaculture equipment, boat hulls, cooling towers, heat exchangers, drinking water distribution systems, membrane filtration, etc.). Biofouling, in particular, is a major challenge and a problematic type of fouling. Often it is not very well understood. Understanding the fundamentals of biofouling, biofouling mitigation and control is widely recognized as one of the most important areas for future research in membrane filtration processes.

The growth of films, fouling and scaling on membrane surfaces leads to a performance decrease in membrane filtration processes. Decreasing permeate flux, increasing pressure drops in membrane modules (i.e., spiral wound reverse osmosis (RO) modules), increasing salt passage in RO, and irreversible damage to the membrane are all examples of issues associated with fouling in membranes. The decrease in membrane performance increases costs (operation and maintenance) and demand for energy, increases the need for membrane cleaning, which further increases chemical demands and cleaning wastes generated, as well as reduces membrane life-time.

There is therefore an increasing interest in developing membrane fouling sensors and fouling mitigation strategies in aquatic systems. Most of the current technologies require destructive techniques. As such there is an interest in developing non-destructive systems.

There is also the challenge of the units not being able to detect the early stages of fouling. Biofilms, organic fouling and scaling occur in all aquatic environments and are of particular concern in engineered systems (e.g., membrane separation processes). For example, there are various biofilm and biofouling detection systems currently available; however for all of these, early detection at the initial phases of biofilm formation is a major challenge.

Accordingly, there is a need to address the aforementioned deficiencies and inadequacies.

### SUMMARY

The global water treatment business (e.g. sewerage works, seawater desalination, wastewater treatment) is expected to expand from around $450 billion in 2010 to a $700 billion market in 2025. Membrane technology is becoming an increasingly important segment in this business. World demand for membranes is expected to rise from around $16.5 billion to $25.7 billion in 2017 (ca. 9.2% yearly), where water treatment will remain the top market. Fouling is an issue that impacts all of these markets.

A device, system and method of assessing fouling are provided herein, for example in water-based systems. In various aspects, the present disclosure provides an in-situ, non-destructive sensor device, system and method to detect or assess fouling at a very early stage of development. Our device, system and method fulfill the requirements of providing an instantaneous quantitative/qualitative response to the presence of fouling. In one or more aspects, they can be used to detect or assess biofouling, in particular biofouling on a surface of an aqueous or aquatic system. They can be used to obtain a depth profile of the biofouling. Data concerning the depth profile of the biofouling can be extracted and used to assess the fouling within a region of interest on the surface. They can be used in connection with various surfaces within aqueous systems, for example, aquaculture equipment, cooling towers, heat exchangers, drinking water distribution systems, membrane filtration, etc. They can also be used to detect or assess fouling on exposed surfaces in aquatic systems, such as boat hulls.

In an embodiment the device, system and method are well suited to be an integral part of fouling mitigation in membrane processes that can maximize cleaning procedures and cycles in order to reduce and control the growth of, for example biofilm, organic fouling and/or scaling in aquatic systems. The device, system and method can be used in any membrane filtration system, e.g. RO desalination, MF/UF pretreatment systems, MF/UF/NF systems in drinking water treatment, MBR technology in wastewater treatment, etc.

In an embodiment, the present disclosure provides a system or device for detecting fouling. The system can comprise: a) an optical tomography device, the optical tomography device configured to irradiate a region of interest on a surface in an aqueous system with a penetrating wave; b) at least one computing device; and c) an application executable in the at least one computing device, the application comprising logic that:

causes the optical tomography device to irradiate at least a portion of a surface within the region of interest with a penetrating wave;

acquires, from irradiating the surface within the region of interest, a plurality of signals as a function of a distance of the surface within the region of interest from the optical tomography device at different times;

extracts intensity data from the signals as a function of the distance to obtain a depth profile of the surface within the region of interest at the different times; and

determines a change in the depth profile between the different times to assess fouling on the surface within the region of interest.

In one or more aspects, the optical tomography device can be an optical coherence tomography (OCT) spectrometer, for example a Spectral Domain Optical Coherence Tomography (SD-OCT) spectrophotometer. The penetrating wave can have a fixed or a variable wavelength. The penetrating wave can be an optical penetrating wave. The penetrating wave can be in the range of 600 nm-1500 nm. The penetrating wave can be in the range of 600 nm-1200 nm. The application logic can determine a change in the depth profile between the different times by extracting data concerning the depth profile at the different times and determining a change in the depth profile data to assess fouling. The data extracted from the depth profile at the different times can include one or a combination of: an area below a peak of the depth profile; a height of a peak of the depth profile; a difference between an initial rise and a peak of the depth profile; or a slope of the depth profile. The application logic can determine a change in the depth profile between the different times by determining a change in a z-projection obtained from the optical tomography device between the different times by extracting data concerning the z-projection at the different times and determining a change in the z-projection data to assess fouling. The z-projection data can be due to a change in intensity of grey or a change in color (for example, a false color scale). A corresponding 2D map can be generated using the z-projection data. Fouling formation can be assessed by the change in intensity of grey or change in color in the corresponding 2D map. The fouling can be due to deposition of a biofilm, organic fouling, scaling or any combination thereof.

In an embodiment a method is provided for detecting fouling. The method can include irradiating the surface of an area to be assessed for fouling and collecting data in the form of spectroscopic data from the irradiation of the surface. The spectroscopic data can be in the form of one or more signals acquired from an optical spectrometer sensor. In one or more aspects, the method can be a method of assessing fouling, comprising: providing a tomography spectrometer including a sensor; optically positioning the tomography spectrometer including the sensor in association with a surface of an area to be assessed for fouling in an aqueous system; irradiating the surface with a penetrating wave; acquiring, from irradiating the surface, a plurality of signals from the sensor as a function of a distance of the surface from the sensor at different times; extracting intensity data from the signals as a function of the distance to obtain a depth profile of the surface at the different times; and determining a change in the depth profile between the different times to assess fouling on the surface. Irradiating the surface can include irradiating the surface with a penetrating wave. The penetrating wave can be an optical penetrating wave. The tomography spectrometer can be an optical coherence tomography (OCT) spectrometer, for example a Spectral Domain Optical Coherence Tomography (SD-OCT) spectrophotometer. The spectrometer can have a wavelength in the range of 600 nm-1500 nm. The penetrating wave can be in the range of 600 nm-1200 nm.

In any one or more aspects, the step of determining a change in the depth profile between the different times can include extracting data concerning the depth profile at the different times and determining a change in the depth profile data to assess fouling. The data extracted from the depth profile at the different times can include one or a combination of: an area below a peak of the depth profile; a height of a peak of the depth profile; a difference between an initial rise and a peak of the depth profile; or a slope of the depth profile. The assessment of fouling on the surface can be determined from one or more of: an increase in the area below a peak of the depth profile; an increase in the height of a peak of the depth profile; an increase between an initial rise and a peak of the depth profile; or a change in slope of the depth profile. The method can include a normalization procedure prior to the determining step. The method can include the step of calibrating the optical tomography spectrometer at a time zero with no fouling deposition on the surface of the area to be detected. A calibration curve function of fouling deposition on the surface can be built, and for example can include introducing a non-transparent object in the area to be detected as an internal standard to provide a calibration. The method can be applied directly to the depth profile. Moreover, the extracted data can be extracted from stacks of acquired images. Each acquired image can be binarized and analyzed through a z-projection function to obtain or generate a corresponding 2D map from which fouling is assessed. Fouling formation can be assessed by the change in intensity of grey or change in color in the corresponding 2D map. The extracted data can be extracted from raw TIFF files and analyzed through a plot z-profile function to obtain the depth profiles to assess fouling. Further, in any one or more aspects of the system or the method the fouling can be due to deposition of a biofilm, organic fouling, scaling or any combination thereof. In any one or more aspects of any of the embodiments the data can be extracted from the signals acquired from irradiating the surface of the area to be assessed and outputted from the tomography spectrometer sensor.

Other systems, methods, features, and advantages of the present disclosure ill be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic of a representative OCT system for use in our present disclosure. FIG. 1B is a schematic of an embodiment of our present disclosure for directly monitoring fouling of a membrane within a vessel. FIG. 1C is a schematic of an embodiment of our present disclosure for indirectly monitoring fouling of a membrane of a vessel using an at-line sensor.

FIG. 2 is a flow chart of a method of the present disclosure.

FIG. 3 is a flow chart of another aspect of the method of the present disclosure.

FIG. 4 is a flow chart of another aspect of the method of the present disclosure incorporating a cleaning cycle.

FIG. 5 is a flow chart of yet another aspect of the method of the present disclosure.

FIG. 6A is a schematic representation of a test system set-up of an example of our present disclosure.

FIGS. 6B and 6C depict Z-projections after 20 hours (FIG. 6B) and 40 hours (FIG. 6C).

FIG. 7 depicts a selected sub-area region of interest for assessing fouling.

FIG. 8 depicts an example of a depth profile.

FIG. 9 depicts examples of changes in depth profiles observed over time.

FIG. 10 depicts normalization and comparison of depth profiles at peak 2 of FIG. 5.

FIGS. 11A-11E show data analysis of profile changes relevant to biofouling observed.

FIGS. 12A-12C depict various depth profiles on a surface of an aqueous system at 0 days, 1 day and 2 days, respectively.

FIG. 13 is a graph of OCT signal vs pressure drop at early stage.

### DETAILED DESCRIPTION

Described below are various embodiments of the present systems and methods for in-situ early detection of fouling in aquatic systems. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure,

### Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art, Such techniques are explained fully in the literature.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Description

In various embodiments, we provide a device, a system and a method for detection of fouling in an aquatic system. The device and system can be an in-situ device and system for aquatic systems. The device, system and method can be based on tomography techniques. In one or more aspects they can be used to detect or assess biofouling. The device, system and method can detect deposition and initiation of a biofilm on a surface at a very early stage due to the high sensitivity of the system.

By tomography techniques, or more simply tomography, we refer to imaging by sections or sectioning, through the use of any penetrating wave. It can be a radiographic technique that produces an image representing a detailed cross-section of a region of interest (ROI). The image data can be manipulated to represent 2D or 3D images (see Appendix B attached hereto and made a point hereof as if fully set forth herein). Examples of penetrating waves that can be used include x-rays, gamma rays, radio-frequency (RF) waves, electrical resistance waves, electron-position annihilation waves (such as used in position emission tomography (PET)), electron waves (such as used in electron tomography or on 3D TEM). The penetrating waves can be optical penetrating waves.

In various aspects optical coherence tomography (OCT) spectrophotometry technology can be used. OCT is a non-invasive, optical diagnostic imaging technique, which enables in-situ or in vivo cross-sectional tomographic visualization of internal microstructure. OCT is analogous to ultrasound imaging except that it can use light rather than sound, thus achieving approximately 1-100× higher image resolution. This can be accomplished by using polychromatic (broad bandwidth) or tunable (variable) light sources in combination with interferometric techniques to detect depth resolved reflectivity profiles, for example due to subtle refractive index changes. Several adjacent one-dimensional optical A-scans can be combined into two-or three-dimensional tomograms for quantitative analysis. Optical coherence tomography (OCT) is an imaging technique that can use light to capture micrometer resolution, three-dimensional images from within optical scattering media. Optical coherence tomography can be based on low-coherence interferometry, typically employing near-infrared light. The use of relatively long wavelength light allows it to penetrate into a scattering medium.

Depending on the properties of the light source (e.g., superluminescent diodes, ultrashort pulsed lasers, and supercontinuum lasers), optical coherence tomography can achieve sub-micrometer resolution (with very wide-spectrum sources emitting over a ˜100 nm wavelength range).

Optical coherence tomography is one of a class of optical tomographic techniques. One suitable OCT technique is Spectral Domain Optical Coherence Tomography (SD-OCT). Other suitable OCT techniques include Frequency Domain Optical Coherence Tomography (FD-OCT), a relatively recent implementation of optical coherence tomography that provides advantages in signal-to-noise ratio permitting faster signal acquisition, Spatially-encoded Frequency Domain OCT (SEFD-OCT), Shear wave imaging OCT (SWI-OCT) and Swept Source OCT (SS-OCT).

In any one or more aspects the device, system and method can include or use a tomography spectrometer, for example an optical coherence tomography (OCT) spectrophotometer, as a sensor based on a penetrating wave imaging technique. The spectrophotometer can use a light source having a fixed or a variable wavelength, for example in the range of 600-1500 nm, and a related probe/lens that can detect small changes on a surface. In other aspects, the range can be 600-1200 nm. These changes can be due, for example, to the deposition of single bacteria and the initial stages of biofilm formation, or other types of fouling within a selected area or region of interest (ROI). The sensor can be positioned over the same area for any given time. This allows the sensor to be calibrated using a scan at time zero with no fouling deposition.

### OCT and Depth Profile

In one or more aspects, the tomography spectrometer can be an Optical Coherence Tomography (OCT) spectrophotometer. The OCT spectrophotometer can include an engine that can create a depth profile from the interference of photons sent (irradiated) into an area or region of interest (ROI) and received back with photons reflected in the reference arm. This depth profile is usually also referred as an A-scan (one dimension (1D) scan). The OCT system can include a digital signal processor for processing the image data and the depth profile.

The OCT spectrophotometer can include an imaging probe (i.e. lens or fiber-bundle) equipped with galvanometer driven scanners, for example two galvanometer driven scanners. When scanning with one mirror while acquiring multiple image scans the device can provide a 2D image (B-scan). Using two mirrors it can provide a 3D image.

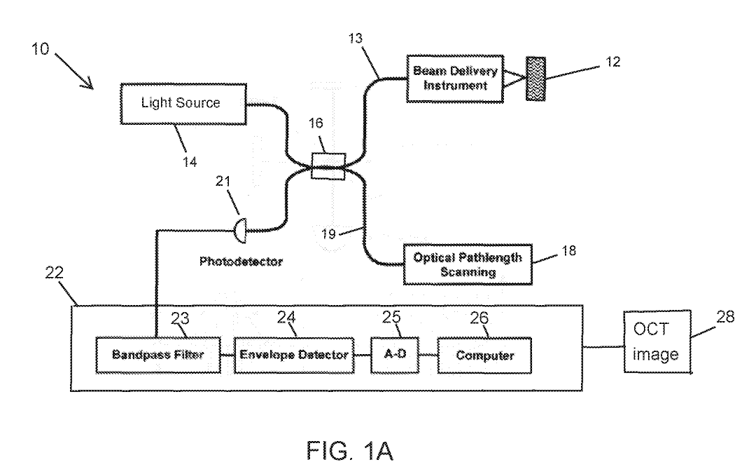

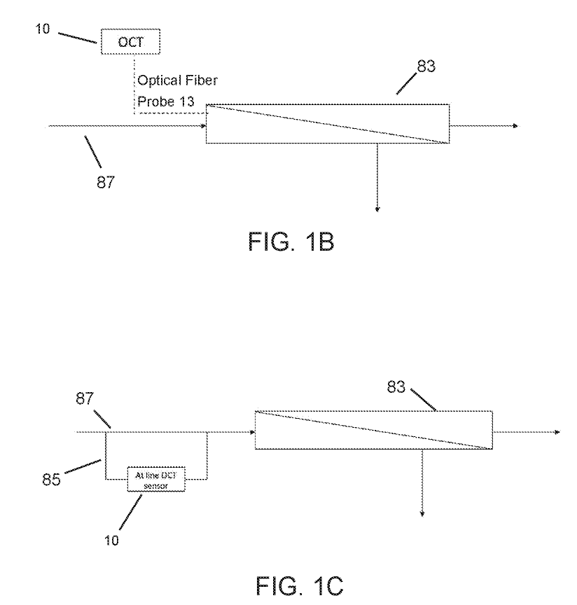

A schematic representation of an OCT system 10 that can be implemented a depth profile of the present disclosure is illustrated in FIG. 1A. The echo time delay of reflected light can be measured by using a Michelson-type interferometer, The interferometer can be implemented using a fiber optic coupler in order to yield a compact and robust system. The light reflected from the specimen or sample 12 is interfered with light 14, which is reflected from a reference path 19 of known path length. The light source can be, for example a low coherence source or a swept source or tunable laser. Light is sent to a beam splitter 16 which can split the light, for example, 50/50 to the sample 12 and the reference 18. Interference of the light reflected from the sample arm 13 and reference arm 18 of the interferometer can occur only when the optical path lengths of the two arms match to within the coherence length of the optical source 14. As the reference-arm optical-path length is scanned, different echo delays of backscattered light from within the sample are measured. The interference signal is detected, for example, by a photodetector 21 at the output port of the interferometer, and passed to a signal processor 22. The signal processor can include a bandpass filter 23 within which the signal can be electronically bandpass filtered, an envelope detector 24 within which the signal can be demodulated, an analog-to-digital converter 25 to digitize the signal, and stored on a computer 26 including a processor. The position of the incident beam on the specimen can be scanned in the transverse direction, and multiple axial measurements can be performed. This generate a 2-D data array, which represents the optical backscattering through a cross-sectional plane in the specimen. A logarithm of the backscatter intensity can then be mapped to a false color or gray scale and displayed as an OCT image 28.

OCT image

The OCT system 10 can provide 2D or 3D images created from a set of 1-D scans (A-scans or depth profiles) wherein the intensity can be converted into an image as a function of the position. In general, OCT imaging is performed by directing (irradiating) an optical beam at an area or ROI to be imaged, and the echo delay of backscattered light is measured. An OCT image can be acquired by performing axial measurements of optical backscatter at different transverse positons (or in a cross-sectional plane) across the area or ROI and displaying the resulting 2-D data set or array wherein for example the intensity is converted into a gray-scale or a false-color image, The image creation is further described in Chapter 22. entitled “Optical Coherence Tomography Imaging in Developmental Biology”, of Methods in Molecular Biology, Vol. 135: Developmental Biology Protocols, Vol. 1, edited by Tuan et al attached hereto as Appendix A which is incorporated by reference as if fully set forth herein.

The area or ROI can be any one or more elements in an aquatic or aqueous system on which fouling may occur. Non-limiting examples include a surface, such as a surface within aquaculture equipment, cooling towers, heat exchangers, drinking water distribution systems, membrane filtration, etc. The surface can be a region of interest of a porous membrane. The surface can also an exposed surface, such as a boat hull. The area or region of interest (ROI) can be one or more elements in a flow cell or observation cell (for example a membrane fouling simulator (MFS)) designed to mimic fouling in an aquatic system. The flow cell or observation cell can be disposed in a branch or shunt line in an aquatic system.

Examples of two different configurations for the implementation of our devices, systems and methods to a full-scale membrane plant (i.e., a desalination) are depicted in FIGS. 1B and 1C. As an example, an optical spectrometer 10, such as an optical coherence tomography (OCT) spectrometer including a sensor, can be fitted to directly monitor fouling in a system or vessel, The optical fiber 13 to the sample of FIG. 1A can be directly mounted inside the vessel 83, such as a spiral wound vessels as depicted in FIG. 1B, Alternatively, the optical spectrometer 10 can be installed in a shunt line 85 in parallel with an input line 87 to the vessel 83 of the plant as depicted in FIG. 1C. In this case, the sensor of the spectrometer 30 can be mounted in association with an MFS module or on a small coupon (for example a few centimeters) containing a feed spacer (or a polypropylene piece) and a membrane 26 separate from the membrane of the vessel 83.

The device, system and method can provide a signal as a function of the distance from the probe (i.e., a depth profile), which can further be transformed into an image. It is possible to obtain a signal for each single pixel or for a selected area. We can also provide an approach, method of calculation and interpretation of the signal(s) to give a better understanding of biofouling at a very early stage.

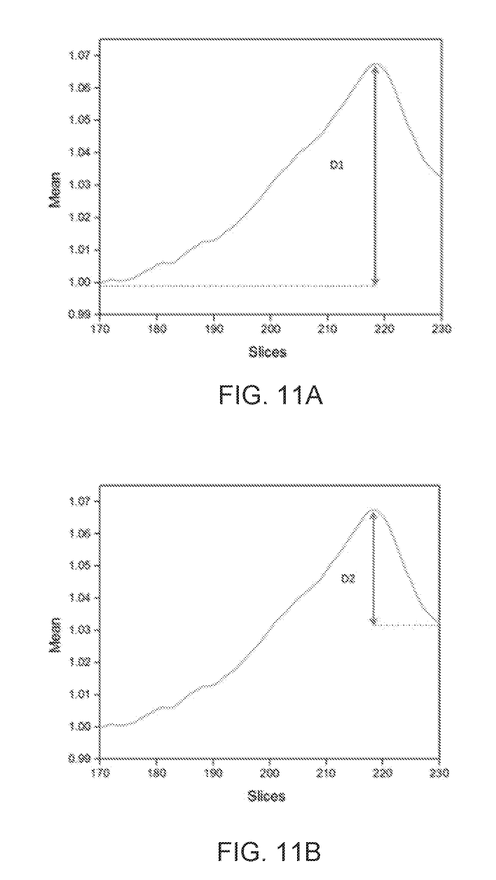

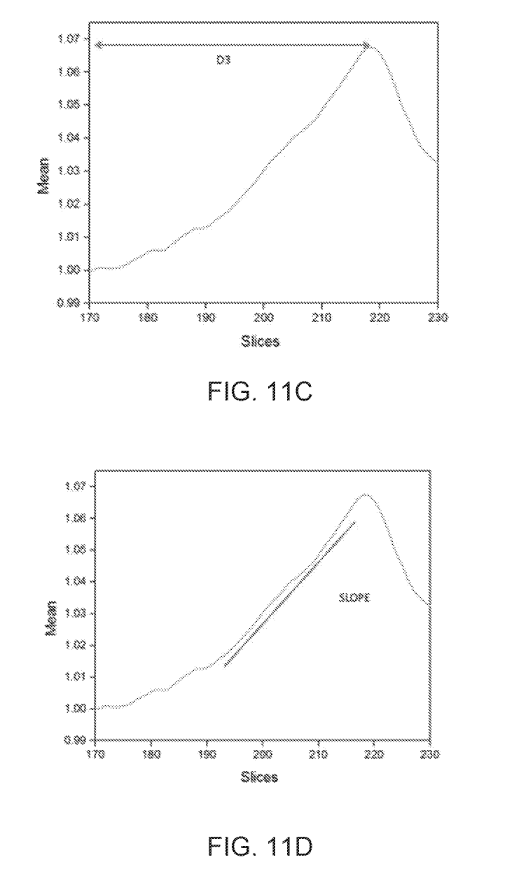

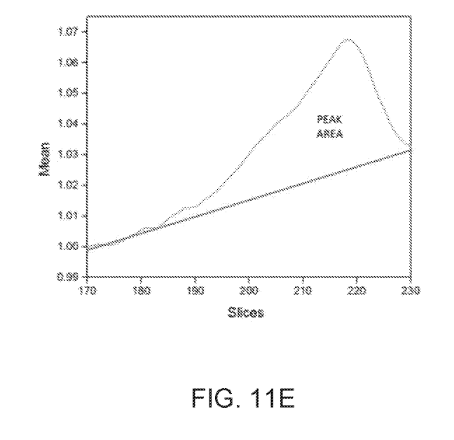

In one or more aspects of the present disclosure, for each signal response different data of a depth profile can be determined such as (see, for example FIGS. 11A-11E):
Area below peak
Height of the peak
Difference between initial rise and peak
Slope

One or more of these determined values from the depth profile data can enable further analysis and detailed confirmation of the early stages of fouling formation, as described in the Examples below. For example, these values from the depth profile data can be evaluated, and it can be determined whether a change in the depth profile data (e.g., a change in one or more of these values) has occurred over time (e.g., between the depth profile data acquired between a first time, a time zero, and a subsequent time, a time x). A normalization procedure can be employed preceding the data determination.

A calibration curve function of the fouling deposition can be built using one of the above information, or any combination thereof. An additional non-transparent object can be introduced in the detected area as an internal standard to provide a second calibration. The optical tomography device typically comes with signal processing software. For example, the OCT software can generate 3D volumetric images. The device can associate a grey value for each pixel. The values of grey intensity can vary depending on the refractive index of the fouling (e.g., the biofilm) which is a function of the fouling material (e.g. EPS composition, cell structures, content of water, etc.) and the distance from the probe. More distinctions can be made by applying specific probes to the various components of the fouling (e.g. IR dye). This allows a distinction between different materials to be made. The 3D images can be used to generate z-projection, for example as discussed below.

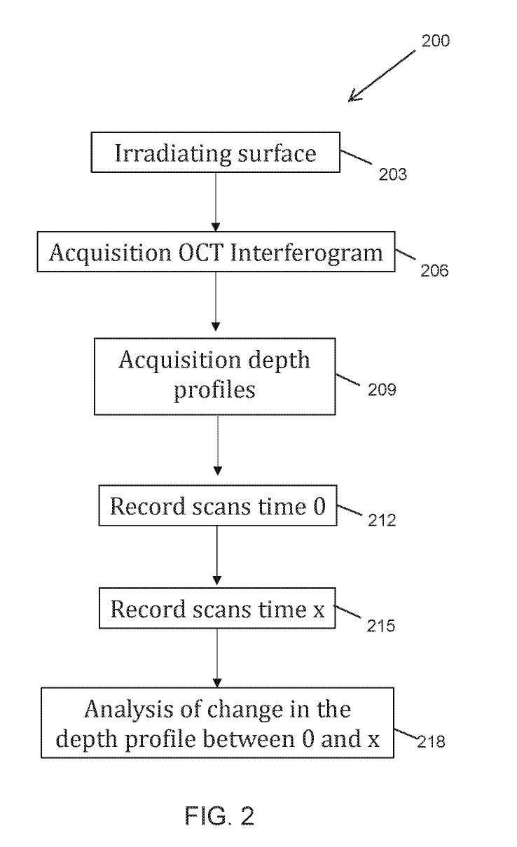

A method for detecting or assessing fouling of the present disclosure is depicted in the flow chart of FIG. 2. The method 200 includes providing a utilizing a tomography spectrometer including a sensor as described herein, for example an Optical Coherence Tomography (OCT) spectrophotometer. The OCT spectrophotometer is optically positioned in association with a surface of an area or region of interest to be assessed for fouling in an aquatic or aqueous system and used to irradiate 203 with at least a portion of the region of interest of the surface as described herein. The irradiation can involve irradiating the surface with a penetrating wave. The irradiation can involve use of a fixed or a variable light source. The wavelength of the light source can be in the range of 600 nm to 1500 nm or in the range of 600 nm to 1200 nm. The sensor of the OCT spectrophotometer can be used to acquire 209 a plurality of signals from the irradiation of the surface. The acquired signals can be a function of a distance of the sensor from the surface and, thus, can be representative of depth profiles. The signals can be acquired from A-scans acquired from the OCT sensor. The acquisition of the depth profiles can involve recording scans at different times. For example a scan can be recorded at a first time 212, for example at a time zero, and a second scan can be recorded at a second subsequent time 215, for example at a time x. The depth profile data recorded at the different times can be analyzed 218 for a change in the data. The analysis can involve extracting intensity data from the signals scanned as a function of a distance of the OCT sensor from the surface at the different times and determining a change in the depth profile between the different times to detect or assess fouling of the surface. The extracted data can include any one or more of the aforementioned values determined from the depth profiles (area below peak, height of the peak, etc.), and determining a change in the depth profiles at the different times can involve determining a change in one or more of extracted data. If desired, a calibration curve function of the detected or assessed fouling of the surface can be built.

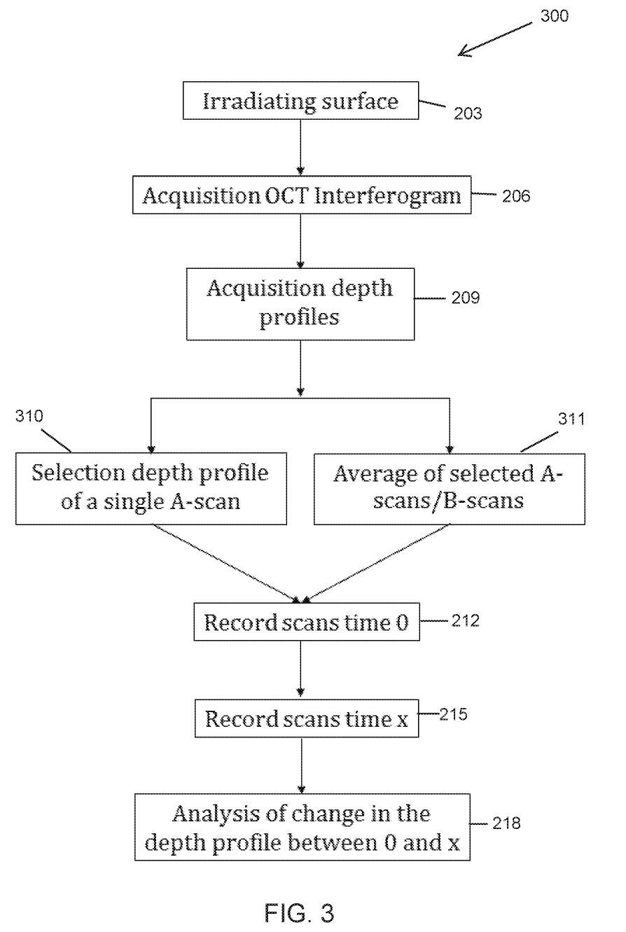

FIG. 3 is a flow chart depicting another aspect of the present method. The method of FIG. 3 is similar to that of FIG. 2, with the exception that the method 300 of FIG. 3 can be applied to the selection or acquisition of a single scan 310 (such as an A-scan) or to a set of scans 311 (such as both A-scans and B-scans) acquired from the OCT sensor that can be recorded at the different times 212, 215. In fact, the OCT can irradiate a 3D volumetric surface with the following acquisition of a set of A-scans and B-scans. Our method can be applied directly to a single scan 310 or to multiple scans 311. Alternatively, a subarea of the irradiated surface can be selected and averaged with the formation of a resulting single scan.

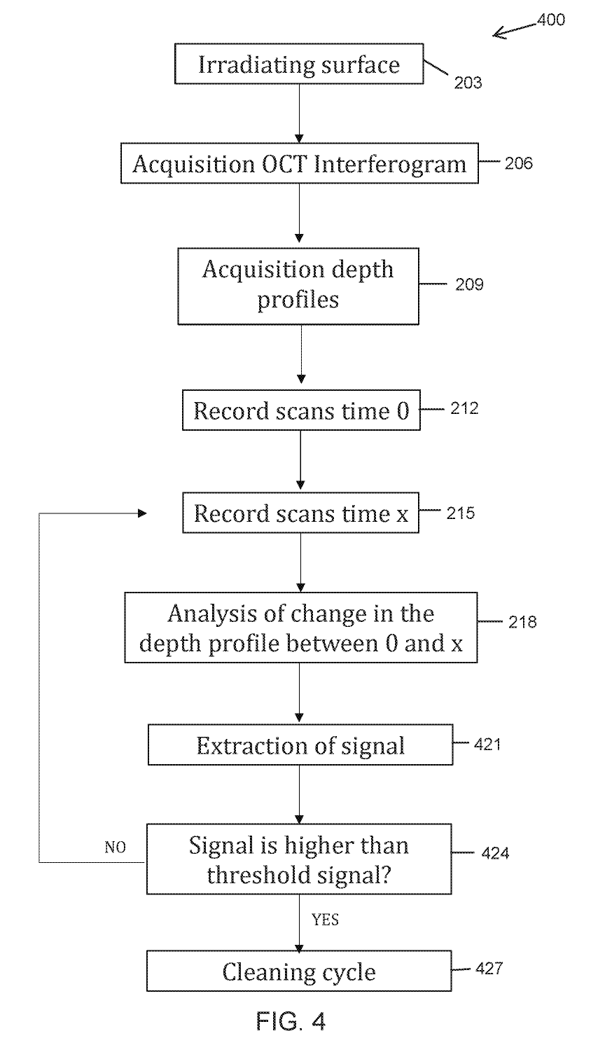

The sensor of the spectrometer 10 can provide a threshold alarm value to allow accommodation of operational strategies such as a cleaning cycle to control the biofilm formation at the earliest stage. The system can be fully automated and work continuously with real-time input to the control systems. FIG. 4 is a flow chart depicting an aspect of the present method incorporating such a strategy. In this method 400 one or more data can be extracted 421 from the acquired signal(s), for example any one or more of the aforementioned depth profile values. A threshold alarm value can be set in connection with such extracted data and a determination can be made whether the data exceeds the set threshold 424 and, if so, a cleaning cycle for the surface (e.g., a surface within a membrane module, membrane vessel or desalination plant unit) can be actuated 427. If the extracted data does not exceed the set threshold, the system and method can be programed to continue to record 215 the acquired scans at selected intervals over different times until the set threshold is exceeded at which time a cleaning cycle can be actuated 427. Such a cleaning cycle can be particularly effective in the system depicted in FIG. 1B.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

### EXAMPLES

### Example 1

A proof of concept was established through a time-series experiment performed on a membrane flow cell (MFC) that represents and emulates a surface in an aqueous system, in particular a commercial spiral wound membrane modules used in reverse osmosis (RO) plants. The MFC is structured with a commercial spacer and flat sheet membrane that can be observed through a glass. The test was performed with an OCT Ganymede 930 nm (Thorlabs) with the LSM03 lens. In order to study biofilm growth on the membrane in the flow cell, an area of 6×6 mm with a physical depth of 1.4 mm was selected where different measurements were recorded over time. Though the test was directed to biofilm growth on the membrane, the system and method can also be used to detect other types of fouling in aquatic systems, such as organic fouling and scaling.

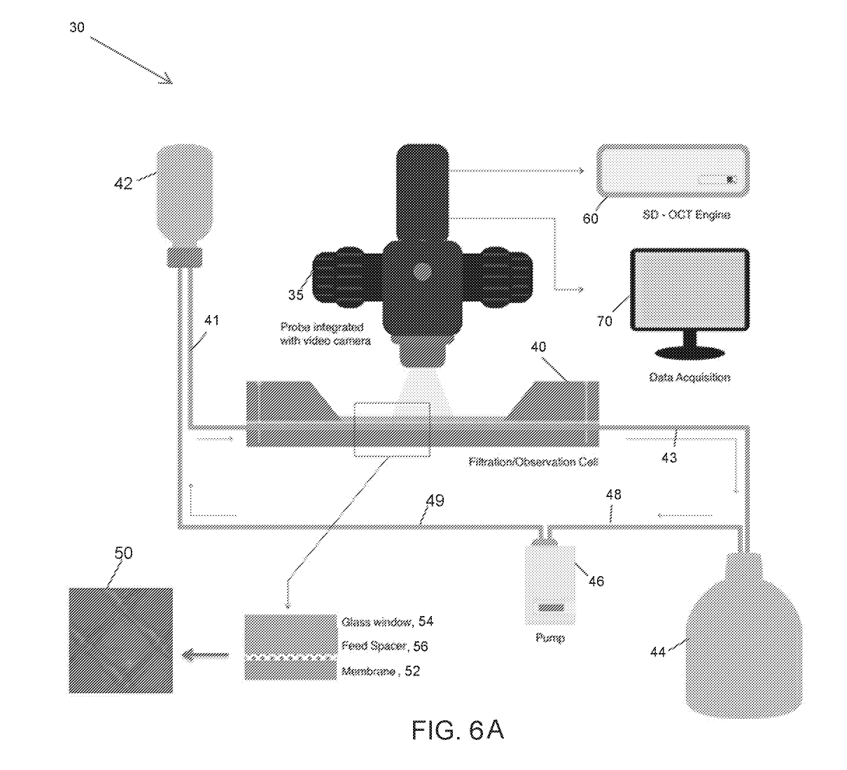

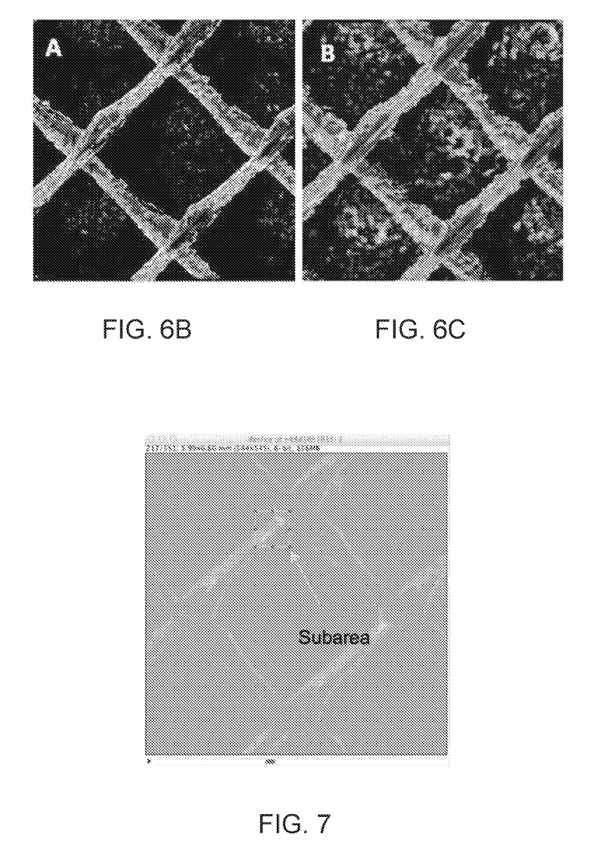

A schematic representation of the test system 30 set-up is depicted in FIG. 6A. The system 30 included an observation cell 40, such as a filtration cell or membrane flow cell. The observation cell 40 included an input line 41 for inputting a liquid feed or test solution for observation into the cell 40 and an output line 43 for removing the liquid feed from the cell. The cell 40 included a membrane layer 52 and a window 54, such as a glass window or a window made of other optically transparent material, spaced apart from the membrane, and a spacer 56 positioned between the membrane 52 and the window 54 to provide a space through which the feed can be input and passed through the cell 40. The membrane layer 52 included an area or region of interest (ROI) 50 for detection of fouling. Coupled or in communication with the input feed line 41 was a first reservoir 42 within which the liquid feed solution was stored. Coupled or in communication with the feed output line 43 was a second reservoir 44 in which feed exiting cell 40 was stored. An output line 48 was coupled to the second reservoir 44, which output line 48 may directly or indirectly communicate with the first reservoir 42. A pump 46 was provided in line with the conduit 48 to assist in passing solution or liquid feed from the second reservoir 44 to the first reservoir 42, in which case a second line 49 was provided coupling the output side of the pump to the first reservoir 42.

One skilled in the art will recognize that observation cells other than that depicted can be used, for example spiral wound nano-filtration (NF) and reverse osmosis (RO) modules. The observation cell may or may not have a spacer. The observation cell may include only a membrane in the form of a flat sheet or a hollow fiber on which or within which fouling may occur. The membrane can also be a porous material or a woven fabric on which fouling may occur.

An optical spectrometer 35, such as an optical coherence tomography spectrometer, was provided spaced apart from the cell 40 and in optical view with the window 54 and the region of interest (ROI) 50 of the cell 40. The optical spectrometer 35 included an integrated probe/lens. The optical spectrometer 35 was configured to provide either a fixed or variable wavelength of light and direct the light through the window 54 of the cell 40 and onto the region of interest 50 of a membrane 52 thereby irradiating the region of interest 50 with either a fixed or variable wavelength of light. The wavelength provided could be in the range of 600 nm-1500 nm or in the range of 600 nm-1200 nm.

An engine 60, such as an optical coherence tomography (OCT) engine (for example, a spectral-domain (SD) OCT engine) was coupled to the optical spectrometer 35. The engine 60 included a processor and could perform optical spectrometer signal processing, for example for irradiating the region of interest (ROI) 50. A data acquisition device 70 was coupled to the optical spectrometer 35 for receiving or acquiring data captured from the spectrometer 35. The acquired data was in the form of one or more signals (for example a plurality of signals) from the sensor of the spectrometer. The acquired data was extracted from the raw signal(s) from the optical spectrometer 35 or any signal(s) outputted from the spectrometer. In one or more aspects the data acquisition device 70 can include a display for displaying images or other means for outputting data. A processor or computing device was provided including logic to receive the acquired data and process the data as described herein.

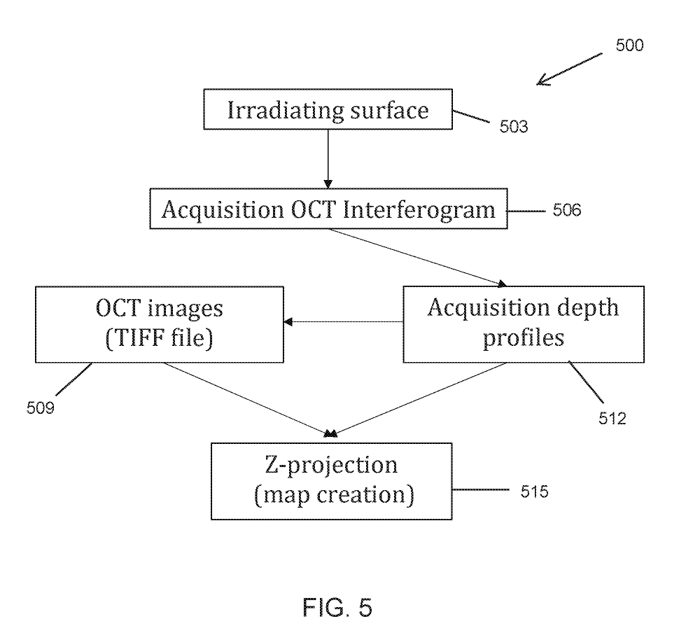

A flow chart of the overall process 500 employed is depicted in FIG. 5. The optical spectrometer 35 was optically positioned with respect to the ROI. A surface of the ROI was irradiated 503 and signals in the form of OCT interferograms were acquired 506. The desired data was extracted from the depth profile 512 or from the raw image(s) 509 acquired and outputted by the spectrometer. In an aspect, stacks of images can be acquired providing a depth profile 512, and the desired data can be extracted from the stack data. The stack data can be used through a z-projection function 515. The z-projection function can be provided in the software provided with the OCT spectrometer or in separate application logic or software. In another aspect the raw data and images can be exported 509 as a TIFF file, where the data can be processed, for example, in the open source software Fiji (ImageJ). The application logic or software can generate 2D maps from the desired data (acquired from the signals, e.g., A-scans, or A-scans and B-scans). For example, 2D maps can be generated from 3D volumetric scans.

### Z-Projection

Stack data from a stack of images at time zero (i.e. no biofouling) was used as a baseline. This formed the basis for determining changes in the depth profile in the area observed by subtracting the baseline from the images subsequently recorded. Each image was binarized and then analyzed through the “z-projection” function 515 to obtain the corresponding 2D image in gray scale. A color mask look up table (16 color) was applied to highlight the presence of biofilm over the surface (see FIGS. 6B and 6C). FIG. 6B depicts an example of z-projections after 20 hours. FIG. 6C depicts z-projections after 40 hours showing a greater degree of biofilm than in FIG. 6B. Biofilm development is therefore displayed as a 2D colored map, with brighter color indicating the presence of biofilm. This method (tool) allows the evaluation of the biofilm deposition on a surface/three-dimensional area. Furthermore a calibration scale can be introduced to quantify the deposition of biofilm.

It is worth noting that the z-projection analysis can display the presence of biofilm (in this case over the spacer) even at the early stage of deposition (see FIGS. 68 and 6C).

### Z Axis Profile

The depth profile or the raw TIFF file without baseline subtraction can be used in an independent second process 509. A sub-area or region of interest (ROI) can be selected for observation (i.e. area subjected to early deposition of biofilm). In this experiment a sub-area of 0.68×0.68×1.4 mm was selected from the raw file (FIG. 7) and the “plot z-axis profile” function was used to obtain a depth profile along the z-axis perpendicular to a surface of interest. In this experiment we scanned the sample in a 3D modality wherein cross-sectional images can be used for 3-D reconstruction. The 3D scans were exported in the .tiff format (which is a way to export a stack of images). We then “processed” the stack of images with the imaging open source software Fiji (ImageJ). We selected a small area (FIG. 7) of the observed area corresponding to the thinner part of the spacer filaments (area subjected to biofouling).

The function of the OCT software “plot z axis profile” plots the mean gray value of a selected area (ROI) versus slice number of the stack of image slices. Through this function we obtained the mean (average) of the depth profiles (A-scan) of that selected area (depth profile=z axis=slice number). We thus obtained an average of depth profiles starting from a tiff file. We carried out the reverse of the process carried out by the device software to create the images. Therefore our method works with the raw file and the images.

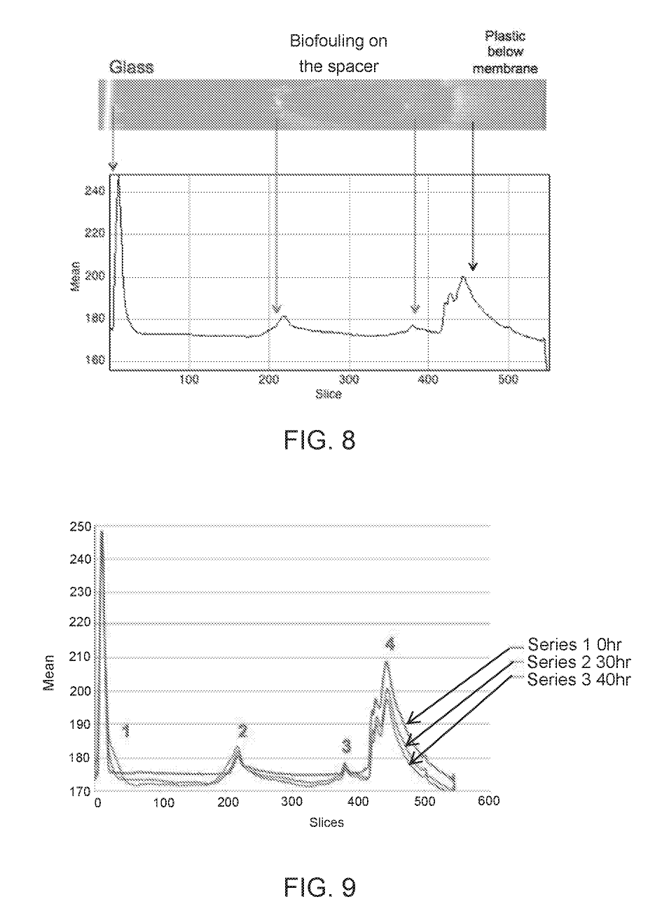

The depth profile (A-scan) is function of the refractive index of the material that the “ray” crosses. The SD-OCT engine can create a depth profile from the interference of photons sent into the sample and received back with photons reflected in the reference arm. This depth profile is referred to as A-scan. The imaging probe can be equipped with two galvanometer driven scanners. When scanning one mirror while collecting multiple A-scans, a 2-dimensional image can be created (referred to as a B-scan). Men scanning both galvanometer mirrors, a volume can be acquired. This can be imaged by movable sections through the volume or by 3D rendering. The depth profile (A-scan) in our case looks like that depicted in FIG. 8.

From this profile the intensity as function of the distance can be extracted, see FIG. 8, allowing one to distinguish between the elements of the flow cell. For each component in the flow cell (i.e., spacer, glass and membrane) a different peak appears in the recorded profile. The first peak corresponds to the glass, the second and third to the spacer and the fourth to the plastic support for the membrane.

The depth profile changed as a function of time (see FIG. 9, times 0, 30, 40 hours) as a consequence of the deposition and growth of a biofilm on the surface. The change in profiles can be summarized as follows:
peak 1, corresponding to the “glass signal”, is observed to expand
peak 2 and peak 3, corresponding to “the spacer signals”, show increasing height and width over time
peak 4, corresponding to the plastic support below the membrane, decreases over time due to reduction of the signal intensity caused by the formation of a biofilm on components closer to the probe.

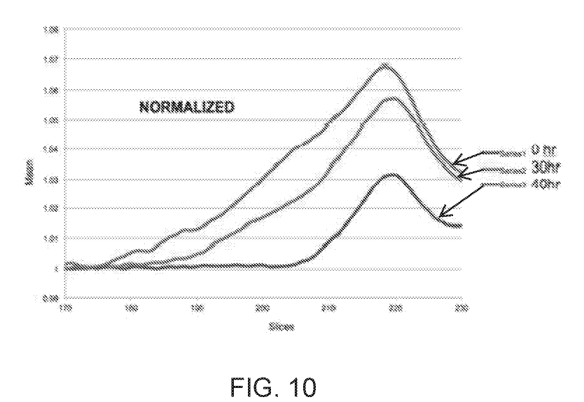

FIG. 10 illustrates how the data can be used, with a normalizing function, Peak 2 of FIG. 9, related to the upper part of the spacer, can be used to build a calibration curve. An appropriate normalization of the curves amplifies the response signal (see FIG. 10). The variation in the signal intensity changes over time can then be used to assess the biofouling behavior.

FIG. 11 exemplifies different analyses that can be done using changes in profile characteristics to quantify and describe the biofouling observed. As shown in the graphs in FIGS. 11A-11E below, the sensor responds to the biofilm presence. For example, the following interpretations can be made:
Increases in the height of the peak (e.g., D1, D2) (FIGS. 11A, 11B)
Increases of the distance, between the peak and straight line (e.g., D3) (FIG. 11C)
Change in the slope of the rise to the maximum peak value (FIG. 11D)
Increase of the area below the normalized peak (FIG. 11E)

An assessment of the depth profiles in FIG. 9 show that even peak 4 can be used to build a calibration curve and, more relevant, can be applied as an internal standard.

### Example 2

A second proof of concept was performed directly on the analysis of the depth profile (A-scan) to test the suitability of the analysis of the change in depth profile described herein.

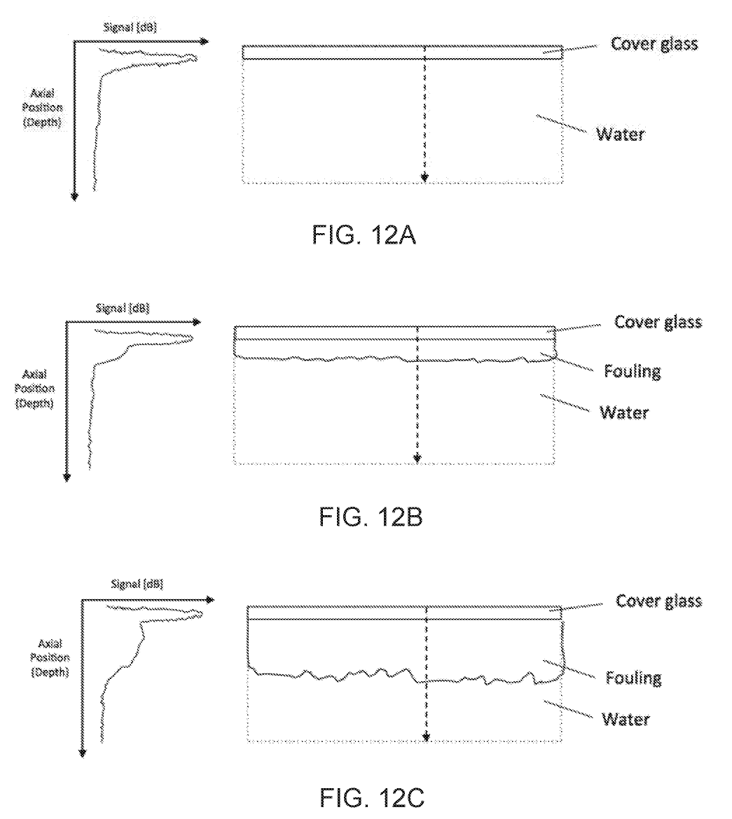

The cover glass 54 of the flow cell 40 was monitored with the OCT for a period of 2 days. The ROI (in this case a single A-scan) of this experiment corresponds to the dashed line in FIGS. 12A-12C. A nutrient solution was used to enhance the formation of fouling which involved dosing yeast extract in the system. The scan at time zero (FIG. 12A) displays only one peak corresponding to the cover glass 54. After 1 day the fouling deposition formed on the glass surface. As shown in FIG. 12B, the formation of fouling leads to a change in the depth profile of the ROI. The formation of fouling on the glass surface is assessed by the presence of a second peak that causes the expansion of the first peak (partial overlap). FIG. 12C shows the change in the profile after 2 days. Once the first deposition is formed, the growth of fouling layer can be assessed analyzing the change in depth profile (FIG. 12C) with the procedure described herein (e.g., area below the peak, height of the peak, difference between initial rise and peak slope).

### Example 3

In membrane filtration processes (e.g., spiral wound elements) biofouling is usually assessed measuring the increase of the feed pressure along the membrane module. This increase is due to the accumulation of biomass in the membrane module flow channel and represents a system headloss.

The same principle applies to a full-scale plant, where the feed pressure increase is recorded for a pressure vessel. The pressure vessel can contain a plurality of modules, for example 6-7 modules. However, as evidenced by membrane autopsies, biofouling typically occurs at the beginning of the pressure vessel and particularly in the first module (referenced to as the lead element). Hence the pressure drop registered for the whole pressure vessel is not enough to detect biofilm formation at early stages where the lead element is mainly affected.

Preliminary experiments were conducted aiming to test the effectiveness of the OCT spectrometer to assess biofouling development at a very early stage in membrane filtration processes. A membrane fouling simulator (MFS) that represents the hydrodynamic conditions of a spiral wound module was used. OCT scans and feed channel pressure drop were recorded over the whole experiment.

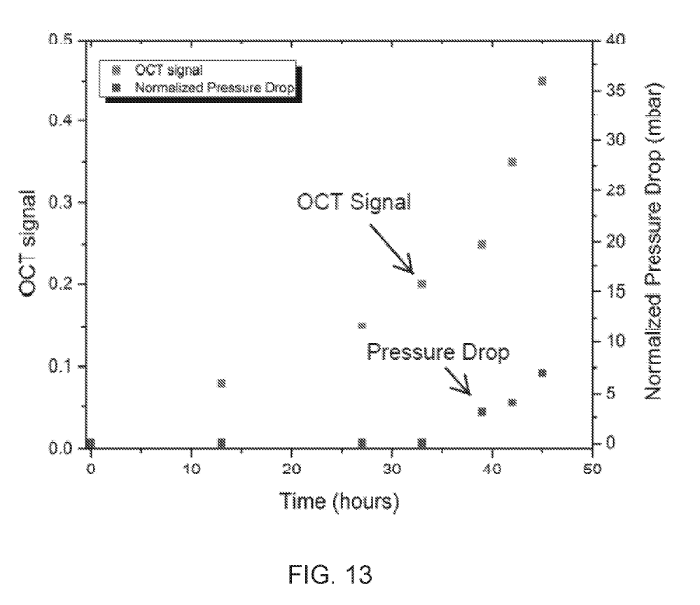

Preliminary results demonstrated that the OCT spectrometer is able to detect biofilm formation at very initial stages before any increase in feed channel pressure is measurable (see, FIG. 13). This finding is even more relevant considering that the MFS used was only 30 cm in length compared to a commercial units applied in full-scale plants consisting of 6 modules, each 1200 cm long.

This shows that our present devices, systems and methods can be used to monitor and assess biofilm formation at a very early stage in membrane filtration processes. We are able to obtain a signal of biomass accumulation directly from the depth profile (A-scan) representative of early stage biofilm formation.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A system for detecting fouling , comprising:
an optical tomography device, the optical tomography device configured to irradiate a region of interest on a surface in an aqueous system with a penetrating wave;
at least one computing device; and
an application executable in the at least one computing device, the application comprising logic that:
causes the optical tomography device to irradiate at least a portion of a surface within the region of interest with a penetrating wave;
acquires, from irradiating the surface within the region of interest, a plurality of signals as a function of a distance of the surface within the region of interest from the optical tomography device at different times;
extracts intensity data from the signals as a function of the distance to obtain a depth profile of the surface within the region of interest at the different times; and
determines a change in the depth profile between the different times to assess fouling on the surface within the region of interest.

2. The system of claim 1, wherein the optical tomography device is an optical coherence tomography spectrometer.

3. The system of claim 1, wherein the penetrating wave has a fixed or a variable wavelength.

4. The system of claim 3, wherein the penetrating wave has a wavelength in the range of 600 nm-1200 nm.

5. The system of claim 1, wherein the application logic determines a change in the depth profile between the different times by extracting data concerning the depth profile at the different times and determining a change in the depth profile data to assess fouling.

6. The system of claim 5, wherein the data extracted from the depth profile at the different times includes one or a combination of:
an area below a peak of the depth profile;
a height of a peak of the depth profile;
a difference between an initial rise and a peak of the depth profile; or
a slope of the depth profile.

7. The system of claim 1, wherein the application logic determines a change in the depth profile between the different times by determining a change in a z-projection obtained from the optical tomography device between the different times by extracting data concerning the z-projection at the different times and determining a change in the z-projection data to assess fouling.

8. The system of claim 7, wherein the change in the z-projection data is due to a change in intensity of grey or a change in color (for example, a false color scale).

9. A method of assessing fouling, comprising:
providing a tomography spectrometer including a sensor;
optically positioning the tomography spectrometer including the sensor in association with a surface of an area to be assessed for fouling in an aqueous system; irradiating the surface with a penetrating wave;
acquiring, from irradiating the surface, a plurality of signals from the sensor as a function of a distance of the surface from the sensor at different times;
extracting intensity data from the signals as a function of the distance to obtain a depth profile of the surface at the different times; and
determining a change in the depth profile between the different times to assess fouling on the surface.

10. The method of claim 9, wherein the tomography spectrometer is an optical coherence tomography spectrometer.

11. The method of claim 10, wherein the spectrometer has a wavelength in the range of 600 nm-1200 nm.

12. The method of claim 9, wherein the step of determining a change in the depth profile between the different times includes extracting data concerning the depth profile at the different times and determining a change in the depth profile data to assess fouling.

13. The method of claim 12, wherein the data extracted from the depth profile at the different times includes one or a combination of:
an area below a peak of the depth profile;
a height of a peak of the depth profile;
a difference between an initial rise and a peak of the depth profile; or
a slope of the depth profile.

14. The method of claim 13, wherein the step of determining a change in the depth profile data includes determining one or more of:
an increase in the area below a peak of the depth profile;
an increase in the height of a peak of the depth profile;
an increase between an initial rise and a peak of the depth profile; or
a change in slope of the depth profile.

15. The method of claim 9, wherein the step of determining a change in the depth profile between the different times determines a change in a z-projection obtained from the optical tomography device between the different times and extracts data concerning the z-projection at the different times and determines a change in the z-projection data to assess fouling.

16. The system of claim 15, wherein the change in the z-projection data is due to a change in intensity of grey or a change in color (for example, a false color scale).

17. The method of claim 10, further including the step of calibrating the optical tomography spectrometer at a time zero with no fouling deposition on the surface of the area to be detected.

18. The method of claim 17, wherein a calibration curve function of fouling deposition on the surface is built.

19. The method of claim 9, wherein the fouling is due to deposition of a biofilm, organic fouling, scaling or any combination thereof.
